(19) United States
(12) Patent Application Publication
(10) Pub. No.: US 2010/0121017 A1
(43) Pub. Date: May 13, 2010

(54) POLYBENZAZOLES AND POLYBENZAZOLE PRECURSORS

(75) Inventors: Anton Peter De Weijer, Nijmegen (NL); Masayuki Chokai, Iwakuni-shi (JP); Hiroaki Kuwahara, Iwakuni-shi (JP); Dennis Wilbers, Iwakuni-shi (JP)

Correspondence Address: OLIFF & BERRIDGE, PLC, P.O. BOX 320850, ALEXANDRIA, VA, 22320-4850, US

(73) Assignee: TIEJIN ARAMID B.V., AV ARNHEM (NL)

(21) Appl. No.: 12/451,122

(22) PCT Filed: Apr. 24, 2008
(86) PCT No.: PCT/EP2008/003298

§ 371 Date: Oct. 27, 2009

(30) Foreign Application Priority Data
Apr. 30, 2007 (EP) 07008742.4

(51) Int. Cl. C08G 63/127; B29C 47/88

(52) U.S. Cl. 528/183; 264/211.12

(57) ABSTRACT

The invention relates to a fiber, pulp, fibril, or fibrid comprising polybenzazole having a repeating unit of formula (I) or (II) wherein Ar¹ and Ar² are independently an aromatic group having 4 to 12 carbon atoms, Ar¹ has the para configuration and 40-100% of the repeating units are repeating unit I and/or repeating unit II and wherein the polybenzazole contains less than 1500 ppm of non-extractable phosphorus compound if 100% of the repeating units are repeating unit I and/or repeating unit II and X and Y are the same. The method allows the manufacture of phosphorous element free a fiber, pulp, fibril, or fibrid containing said polybenzazole precursor or polybenzazole and a spinning method for obtaining said fiber, pulp, fibril, or fibrid.

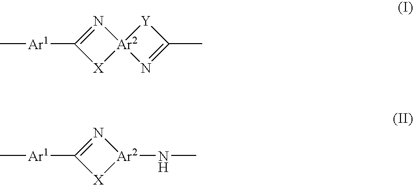

The present invention relates to a fiber, pulp, fibril, or fibrid comprising polybenzazole or polybenzazole precursor, and to novel polybenzazoles and precursors thereof. The invention further relates to a process for converting a polybenzazole precursor to a polybenzazole, and to a process of polymerizing monomers to the polybenzazole precursor. In another aspect the invention pertains to a spinning process for making fiber, pulp, fibril, or fibrid.

Aromatic polybenzazoles are known as polymers having superior heat resistance, high strength, high modulus, and high resistance to chemicals. Hitherto, various methods of manufacturing aromatic polybenzazole have been proposed. For example, U.S. Pat. No. 3,047,543 describes a method for obtaining low-molecular weight aromatic polybenzazole by a melt polymerization method. Japanese patent application H5-112639 describes a method for obtaining polybenzoxazole with polyphosphoric acid as the solvent. However, polyphosphoric acid is corrosive, and it requires the use of an apparatus made of expensive alloys that are resistant to corrosion. Moreover, a phosphorous compound such as polyphosphoric acid cannot fully be removed from the inside a polymeric fiber, not even after extensive extraction by a washing procedure, and the residue remaining in the polymer often leads to the problem of degrading polymer properties. Even the use of the most intensive washing and extraction procedures leads to polybenzoxazole fibers containing more than 4.10³ ppm of phosphorous compound (herein further called non-extractable phosphorous compound; method used ASE extraction method). Thus it is practically impossible to obtain polybenzoxazole fibers which are free or virtually free of phosphorous compounds when spun from a polyphosphoric acid spin dope.

Methods using solvents other than phosphoric acid have also been proposed. For example, Japanese patent application S43-2475 describes a manufacturing method in which aromatic polyamide having a hydroxy group is manufactured using an organic solvent, and the reactive solution containing the organic solvent and the aromatic polyamide is spun unchanged. Then, the organic solvent is removed and heated for ring closure to obtain a polybenzoxazole fiber. However, the mechanical properties of the fiber obtained by using a reactive solution containing aromatic polyamide at low concentrations are unsatisfactory.

In US 2005/249961 PBO film has been described prepared from prepolymers containing silanized hydroxy groups. These prepolymers are prepared in phosphorous-containing solvents rendering PBO polymers containing substantial amounts of phosphorous.

In WO 2007/008886 a method for making polybenzobisoxazole containing fiber is described. According to this method PPTA, which is an unsubstituted aromatic polyamide, is oxidized in a sulfuric acid acetic acid mixture to introduce hydroxy groups onto a portion of the aromatic moieties. This method leads to copolymers wherein up to 15% of the diaminophenyl moieties are hydroxylated. This method thus renders copolymers having fairly low hydroxylated diaminophenyl content. These copolymers therefore cannot be used to prepare rigid rod polymers such as PBO, because at the best only 15% of the aromatic units can ring close to benzazole units. It should further be remarked that the heat treatment to effect ring closure is performed at 185° C. for 15 minutes, which temperature is too low and which reaction time is too short to effectively perform ring closure when using copolymers having higher hydroxyl contents.

Other references disclosing PBO products made from a phosphorus containing dope are, for instance, WO 92/00353, U.S. Pat. No. 5,273,823, and U.S. Pat. No. 5,098,985 (or its corresponding EP 368006).

As described above, it is possible to manufacture aromatic polybenzazole with a high molecular weight by means of a method using a phosphorous compound such as polyphosphoric acid as the solvent. However, this method has the problem of corroding the apparatus with the phosphorous compound, and of degrading the polymer due to residual phosphorous compound within the polymer.

Meanwhile, it is known to manufacture aromatic polyamides having a hydroxy group by using an organic solvent or by hydroxylating aramid polymers in a sulfuric acid acetic acid mixture, and to manufacture fiber by using a reactive solution containing a low concentration of aromatic polyamide, and heating and ring closing the polymer to give fibers comprising polybenzoxazole. However, even with the use of an amorphous solution containing a low concentration of aromatic polyamide, it is difficult to obtain fibers that are highly aligned and have superior mechanical properties.

An objective of the present invention is to provide fiber, pulp, fibril, or fibrid comprising aromatic polybenzazole that have superior mechanical properties such as elastic modulus and strength.

An objective of the present invention is also to provide fibers, pulp, fibrils, film or fibrid comprising aromatic polybenzazole that can be manufactured without using a phosphorous compound such as polyphosphoric acid.

It is further an objective of the present invention to provide novel polybenzazoles, such as novel polybenzoxazoles and other novel polybenzazoles, as well as their novel precursors.

It is another objective to spin or extrude the polybenzazoles or their precursors to fiber, pulp, fibril, or fibrid.

It has now been found that fiber, pulp, fibril, or fibrid having superior properties, including mechanical properties, can be obtained by a process in which an optical anisotropic dope, containing a high concentration of a high molecular weight aromatic polyamide having a substituent such as a hydroxy, thiohydroxy, or amine group in an acidic solvent, is applied using a wet air gap spinning process, a jet spinning process, or any other conventional method to obtain a fiber, pulp, fibril, or fibrid, which are then heat treated. These fibers, pulps, fibrils, and fibrids contain only extreme low amounts of phosphorus compounds, such as polyphosphoric acid residues, and preferably are free from such phosphorus contaminants. Furthermore, it has been found that the use of an acidic solvent in the dope for manufacturing polybenzazole fiber, pulp, fibril, and fibrid has the advantage that the acidic solvent can easily be removed by rinsing with water, which is less likely to leave residue within the fiber, pulp, fibril, or fibrid.

The present invention relates to a fiber, pulp, fibril, or fibrid comprising polybenzazole having a repeating unit of formula (I) and/or (II)

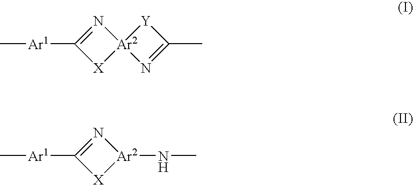

wherein Ar¹ and Ar² are independently an aromatic group having 4 to 12 carbon atoms, Ar¹ has the para configuration, and X and Y are the same or different and selected from O, S, and NH; and wherein fiber contains between 30.1 ppm and 1500 ppm of non-extractable phosphorus compound, and pulp, fibril, or fibrid contains less than 1500 ppm of non-extractable phosphorus compound if X and Y are the same.

It is essential that Ar¹ has the para configuration to obtain high modulus linear polymers. If Ar¹ (and Ar¹ in the non-cyclized polybenzazole precursor) have a meta configuration, the polybenzazole polymers will have kinks in the molecular backbone, resulting in inferior mechanical properties. The problem of the desired para configured polybenzazole polymers is their low solubility, whereas the unwanted meta polybenzazole usually are easily soluble.

As background art U.S. Pat. No. 4,018,735 is mentioned, which reference discloses aramid polymers. These aramid polymers differ from the presently claimed rigid rod polymers in that the aromatic unit Ar¹ is bonded via a nitrogen atom to the terephthalic unit, whereas the corresponding aromatic group Ar¹ in the present polymers according to formula II is the terephthalic unit and therefore bonded via a carbonyl group to the nitrogen atom of Ar².

U.S. Pat. No. 4,820,793 discloses polymers that have been used to cast on a glass plate to form a coating film. This reference does not disclose fiber, pulp, fibril, or fibrid, or methods for making these.

The present fibers, pulp, fibrils, films, or fibrids are manufactured by a method comprising the steps of spinning or extruding a dope and solidifying it to a coagulation liquid, and then subjecting the obtained fiber to heat treatment at 200-900° C., wherein said dope contains aromatic polybenzazole precursor with relative viscosity (ηᵣₑₗ) of 1.5 or higher and a solvent, and has a polybenzazole precursor concentration of less than 40 wt %.

The polybenzazole precursor contains the repeating unit expressed by the following formula (IV):

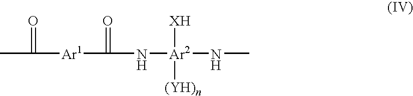

wherein Ar¹ and Ar² are independently an aromatic group having 4 to 12 carbon atoms, Ar¹ and Ar² have the para configuration, X and Y are the same or different and selected from O, S, and NH, and n is 0 or 1.

The polybenzazole precursor containing one of the following repeating units is especially preferred.

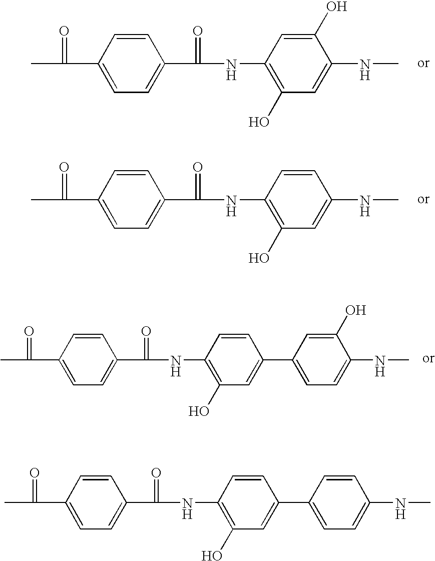

The fiber, pulp, fibril, or fibrid of the present invention comprise polybenzazole containing a repeating unit expressed by the formula I or II, or they contain both repeating units. When the repeating unit is only according to formula (I) and X and Y are the same, fiber or pulp containing more than 4.10³ ppm phosphorous compound are known from processes using polyphosphoric acid as dope. Some references claim content lower than 4.10³ ppm, i.e. 3.10³ ppm or even 2.10³ ppm. Fibril or fibrid are not disclosed at all, but if prepared according to the conventional methods they probably will also contain considerable amounts of phosphorous compound. These fiber, pulp, fibril, or fibrid are not encompassed in the present claims. The invention also claims fiber, pulp, fibril, or fibrid comprising the repeating unit expressed by the formula I wherein X and Y are different, and/or the repeating unit expressed by the formula II wherein Ar¹ is a bivalent para-aromatic group with 4 to 12 carbon atoms. Examples of Ar¹ are phenylene, naphthalenediyl, and bivalent heteroaromatic groups. Ar¹ may be substituted with hydroxy and/or halogen groups.

Ar¹ is preferably selected from

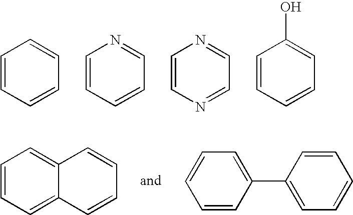

Ar² is a tri- or quadrivalent aromatic group with 4-12 carbon atoms. Examples of A² are benzenetri- or tetrayl, naphthalenetri- or tetrayl, diphenyltri- or tetrayl, and tri- or quadrivalent heterocyclic group can be listed as Ar². These Ar² moieties may be substituted with a hydroxy and/or halogen group.

Ar² is preferably selected from:

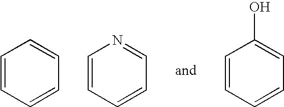

The benzene group is the most preferred Ar² group.

Since X is an oxygen atom (—O—), sulfur atom (—S—), or imino group (—NH—), the polybenzazole contains imidazole, thiazole, and/or oxazole rings.

In a preferred embodiment Ar¹ is

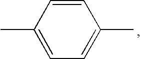

Ar² is

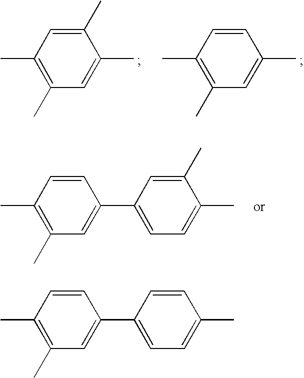

### and X and Y are O.

In addition to the above polybenzazole the fiber may also be a copolymer containing repeating units expressed by formula (III)

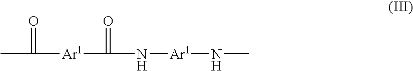

In formula (III), the Ar¹ groups have independently the previously given meanings. The preferred Ar¹ is para-phenylene.

The polybenzazole preferably comprises 40 to 100 mole % of the repeating unit expressed by formula (I) and/or (II) with 60 to 0 mole % of the repeating unit expressed by formula (III), to a total of 100 mole %.

The polybenzazole preferably comprises 60 to 100 mole % of the repeating unit expressed by formula (I) and/or (II) with 40 to 0 mole % of the repeating unit expressed by formula (III), to a total of 100 mole %.

The relative viscosity (ηᵣₑₗ) of the polybenzazole that constitutes the fiber, pulp, fibril, or fibrid of the present invention is 1.5-100, preferably 2.0-50, and more preferably 3.0-40. The relative viscosity (ηᵣₑₗ) of polybenzazole is a value measured using methane sulfonic acid with a polymer concentration of 0.03 g/100 mL at 30° C. The amount of non-extractable phosphorus atoms within the polybenzazole that constitutes the fiber, pulp, fibril, or fibrid of the present invention is less than 1500 ppm, which means that these fiber, pulp, fibril, or fibrid cannot have been prepared from a polyphosphoric acid spin dope. Preferably, the fiber, pulp, fibril, or fibrid is free or virtually free from phosphorous, i.e. contains 0-20 ppm and more preferably 0-10 ppm of phosphorus atoms. If a dope not containing any phosphoric acid is used the fiber, pulp, fibril, or fibrid will be totally free of phosphorus compound. The elastic modulus of the fibers of the present invention is preferably not less than 70 Gpa, more preferably 100-500 Gpa, and even more preferably 120-350 Gpa. The single fiber fineness of the fibers of the present invention is preferably 0.01-100 dtex, more preferably 0.1-10 dtex, and most preferably 0.5-5 dtex. The strength of the fibers of the present invention is preferably 500-10,000 mN/tex, more preferably 1,000-5,000 mN/tex, and most preferably 1,200-4,000 mN/tex. The break elongation of the fibers of the present invention is preferably 0.1-30%, more preferably 0.5-10%, and most preferably 1.0-8.0%.

The fibers of the present invention preferably have an alignment factor F of not less than 0.3 that can be obtained by the following formula:

$$< {cos}^{2} φ >= \frac{\text{?} I ( φ ) {cos}^{2} φ sin φ d φ}{\text{?} I ( φ ) sin φ d φ}$$

$$F = \frac{3 < {cos}^{2} φ > - 1}{2}$$

$$\text{?} \text{indicates text missing or illegible when filed}$$

wherein φ is an azimuth in X-ray diffraction measurement, and I is the diffracted intensity of the X-ray.

More preferably the alignment factor is no less than 0.8, even more preferably not less than 0.9, and most preferably not less than 0.95. It is desirable to have a higher value of alignment factor F, because the higher the value, the higher the elastic modulus of the fiber. The theoretical upper limit of the alignment factor F with a complete alignment is 1.0.

In the present invention, the polybenzazole precursor is obtained by polymerizing dicarboxylic acid compound or derivative thereof, preferably the dichloride, expressed by the formula (A) and aromatic diamine, or its hydrochloride, hydrosulfate, or phosphate salt, expressed by the formula (B) or (C).

LGOC-Ar¹-COLG (A)

H₂N—Ar¹—NH₂ (B)

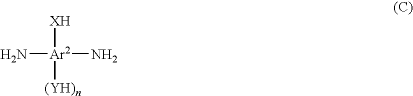

wherein Ar¹, Ar², X, Y, and n have the previously given meanings and LG is a leaving group. The reaction is performed in a phosphoric acid free solvent. Leaving groups are well known in the field, and common leaving groups are alkyl or aryl esters, halogens like chlorine, bromine or iodine, tosylate, brosylate, and the like.

Particularly suitable is chlorine.

The product obtained is a polybenzazole precursor consisting of repeating units

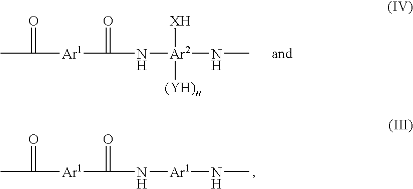

wherein Ar¹ and Ar² are independently an aromatic group having 4 to 12 carbon atoms, Ar¹ and Ar² have the para configuration, X and Y are the same or different and selected from O, S, and NH, and n is 0 or 1; and 40-100% of the repeating units are repeating unit IV. Most preferred are those precursors wherein Ar¹ and Ar² are a benzene moiety and X is O.

The above polybenzazole precursor can be converted to the polybenzazole according to a method comprising the step of heat treating the polybenzazole precursor under an inert atmosphere at 250 to 600° C. for 0.5 sec to 24 h.

With regard to the solvent used for polymerization, there is no specific limitation. Any solvent can be used as long as it is able to melt the above mentioned raw material monomers, and it is substantially non-reactive with these. However, if both X and Y are present and X and Y are the same, polyphosphoric acid or other phosphorous acids are excluded because they lead to a product having considerable amounts of non-extractable phosphorous atoms. It is possible to obtain a polymer with an relative viscosity of at least 1, and more preferably not less than 1.2. For example, amide solvents such as N,N,N′,N′-tetramethylurea (TMU), N,N-dimethylacetamide (DMAC), N,N-diethylacetamide (DEAC), N,N-dimethyl propionic amide (DMPR), N,N-dimethyl butylamide (NMBA), N,N-dimethyl isobutyl amide (NMIB), N-methyl-2-pyrrolidinone (NMP), N-cyclohexyl-2-pyrrolidinone (NCP), N-ethylpyrrolidone-2 (NEP), N-methyl caprolactam (NMC), N,N-dimethyl methoxy acetamide, N-acetylpyrrolidine (NARP), N-acetylpiperidine, N-methylpiperid-2-one (NMPD), N,N′-dimethyl ethyleneurea, N,N′-dimethylpropylene urea, N,N,N′,N′-tetramethyl malonamide and N-acetylpyrrolidone, or phenolic solvents such as p-chlorophenol, phenol, m-cresol, p-cresol and 2,4-dichlorophenol, or combinations of the above compounds can be used. The preferred solvents are N,N-dimethylacetamide (DMAC) and N-methyl-2-pyrrolidinone (NMP).

For better solubility, an appropriate amount of inorganic salt may be added before polymerization, midstream, or at the end. For example, lithium chloride and calcium chloride can be used for this purpose. Most preferred solvent is NMP/CaCl₂.

It is preferred to use dry solvents. Usually the reaction temperature is at the most 80° C., and preferably below 60° C. Furthermore, the preferred monomer concentration is approximately 1-20 wt %. Moreover, it is possible to use trialkylsilyl chloride in the present invention to obtain a high degree of polymerization. Moreover, during the reaction of acid chloride and diamine, quaternary ammonium base can be used to capture acids such as hydrogen chloride that are generated.

The dope for use in the present invention contains less than 40 wt % of the above-mentioned polybenzazole precursor, preferably less than 30 wt %, and most preferably 2-30 wt %. Solvents that are used for making the polymer are also ideally be utilized as for the dope. This has the advantage that isolation of the polymer from the solvent is not necessary. If an acidic solvent is used preferably fuming sulfuric acid, sulfuric acid, methane sulfuric acid, or an aqueous solution and mixtures thereof are applied. The sulfuric acid is preferably concentrated sulfuric acid with a concentration of not less than 98 wt %. A very suitable dope is water having pH>8, more preferably water containing sodium hydroxide and/or tetramethylammonium hydroxide Furthermore, it is preferable that the dope is optically anisotropic. The optical anisotropy, for example, can be determined by sandwiching the dope between two glass plates, and determining the optical anisotropy under a microscope with a cross Nicol filter.

The dope can be prepared by dissolving polybenzazole precursor into the solvent. Furthermore, it can be prepared by kneading and dissolving after obtaining an arenaceous dope by bringing the solvent in the form of ice into contact with the at a low temperature.

The dope can be spun by extruding through a fiber spinneret or extruded through a die. The methods for making fiber, pulp, fibril, or fibrid are conventional and known in the art. Particularly useful is a method of obtaining the fiber, pulp, fibril, or fibrid of claim 1 comprising the steps of:
extruding a solution comprising 25 to 100 mole % of the polybenzazole precursor and to a total of 100 mole % of the polybenzazole polymer in a phosphoric acid-free dope through a die or spinneret to obtain a fiber, pulp, fibril, or fibrid;
drawing the fiber across an air gap;
coagulating the fiber, fibril, pulp, fibrid or film in a coagulation bath;
optionally washing the fiber, fibril, pulp, fibrid or film; and
optionally drying the fiber, fibril, pulp, fibrid or film;
heat treating the fiber, fibril, pulp, fibrid or film to convert the polybenzazole precursor to the polybenzazole, optionally followed by washing and drying steps.

The fiber spinneret is preferably made of a corrosion-resistant metal such as gold, platinum, palladium, rhodium, or alloys thereof. After fiber spinning, the polymer is solidified to a coagulation liquid. The coagulation liquid is preferably an aqueous solution of sulfuric acid or methane sulfuric acid, or water. The temperature of the coagulation liquid is preferably −30 to150° C., more preferably 0 to100° C., and most preferably 5 to 50° C.

The spun fibers are preferably drawn before being solidified to a coagulation liquid. Drawing is preferably performed in an air gap. The air gap is an open space positioned between the spinneret and the coagulation liquid. When a dope is extruded through fine holes of a spinneret, shear forces at the fine holes align the liquid crystal domain into the flow direction, but the alignment of the liquid crystal domain deteriorates at the exit of the fine holes due to the viscoelastic property of the dope. It is for this reason that the deteriorated parts should be restored by drawing in the air gap. Deterioration of alignment can easily be restored by elongating and thinning fibers by applying drawing tension.

The drawing ratio is preferably 1.5-300, more preferably 2.0-100, and most preferably 3.0-30 times. The drawing ratio is calculated from the ratio of the discharge speed of the dope from a spinneret and the take-up speed of the solidified thread. Finally, it is preferable to wash, neutralize, rewash, and dry the fibers.

In the present invention, the obtained fiber, pulp, fibril, or fibrid are preferably further processed with heat treatment at 250-600° C. The heat treatment temperature is preferably 300 to 550° C., and more preferably 350-500° C. The heat treatment can be performed under an inert atmosphere such as in air, nitrogen, or argon. The heating treatment is performed for 0.5 sec to 24 h, and it is evident that the higher the temperature the shorter heating times are required.

As a result of the heat treatment, a cyclization reaction occurs between the -XH, and if present the -YH groups, to give from the open structure (III) a polybenzazole having structure (I) or (II).

Furthermore, it is advantageous to perform the heat treatment under tension. The tension applied at the time of heat treatment is preferably 0.1-80%, and more preferably 1-30% of the tenacity of the fiber before heat treatment. The time of heat treatment is preferably 1 sec-30 min, more preferably 10 sec-10 min, and most preferably 1-5 min.

The present invention will be explained more specifically by the following embodiments. However, the present invention is not limited to these embodiments.

The term jet spinning means a spinning process as, for instance, has been disclosed in WO 2004/099476. According to this method the liquid para-aramid polymerization solution is supplied with the aid of a pressure vessel to a spinning pump to feed a nozzle for jet spinning to pulp-like fibers under pressure. The liquid para-aramid solution is spun through a spinning nozzle into a zone of lower pressure. Under the influence of the expanding air flow the liquid spinning solution is divided into small droplets and at the same time or subsequently oriented by drawing. Then the pulp- like fibers are coagulated in the same zone by means of applying a coagulant jet and the formed pulp is collected on a filter, or directly processed to paper, or the fibers are laid down on a plate to directly form paper and thereafter coagulated. The coagulant may be selected from water, mixtures of water, NMP (N-methylpyrrolidone), and CaCl₂, or any other suitable coagulant.

In WO 2005/059247 the making of fibrids was described. According to this method the dope is converted to para-aramid fibrid film by spinning the dope through a jet spin nozzle to obtain a polymer stream, hitting the polymer stream with a coagulant at an angle wherein the vector of the coagulant velocity perpendicular to the polymer stream is at least 5 m/sec (preferably at least 10 m/sec) to coagulate the stream to para-aramid fibrid films. According to another method described in this reference the dope is coagulated by means of a rotor-stator apparatus in which the polymer solution is applied through the stator on the rotor so that precipitating polymer fibrids are subjected to shear forces while they are in a plastic deformable stage.

For making a polymer-additive material composite pulp or fibril a similar method can be used comprising converting the dope to pulp or fibrils by using a jet spin nozzle under a gas stream, followed by coagulating the pulp or fibrils using a coagulation jet.

Properties in the embodiments were measured by the following methods.

Relative Viscosity (ηᵣₑₗ)

The relative viscosity (ηᵣₑₗ) of polybenzazole precursor was measured using 95 wt % concentrated sulfuric acid with a 0.5 g/100 mL polymer concentration at 30° C. The relative viscosity (ηᵣₑₗ) of was measured using methane sulfuric acid with a polymer concentration of 0.03 g/100 mL at 30° C.

### Strength, Break Elongation, and Elastic Modulus

Strength, break elongation, and elastic modulus were measured by pulling a single fiber with a tension speed of 10 mm/min. using the TENSILON™ universal-testing machine 1225A manufactured by Orientech Inc.

### ASE Extraction Method

The samples were extracted with MilliQ water using an Accelerated Solvent Extractor (ASE) under the following conditions:
temperature 115° C.
pressure 68.9 bar (1000 psi)
preheat 0 minutes
heat up time 5 minutes
static time 15 minutes
flush volume 100% of cell
static cycles 2

### Method of Measuring the Amount of Phosphorus Atoms

Approximately 0.15 g of an extracted sample were weighed and destructed with H₂SO₄/H₂O₂. Measurements were performed with ICP-OES at the axial Vista Pro™ from Varian at the most appropriate phosphorus emission lines, applying the Y 371.029 nm line as internal standard.

### Fiber Length

Fiber length measurement was done using the Pulp Expert™ FS (ex Metso). As length the average length (AL), the length weighted length (LL), weight weighted length (WL) were used. The subscript 0.25 means the respective value for particles with a length>250 microns. The amount of fines was determined as the fraction of particles having a length weighted length (LL)<250 microns. This instrument was calibrated with a sample with known fiber length. The calibration was performed with commercially available pulp as indicated in Table 1.

TABLE 1

| Commercially | | | | | | | |
|---|---|---|---|---|---|---|---|
| available | AL | LL | WL | AL_{0.25} | LL_{0.25} | WL_{0.25} | Fines |
| samples | mm | mm | mm | mm | mm | mm | % |
| A | 0.27 | 0.84 | 1.66 | 0.69 | 1.10 | 1.72 | 26.8 |
| B | 0.25 | 0.69 | 1.31 | 0.61 | 0.90 | 1.37 | 27.5 |
| C | 0.23 | 0.78 | 1.84 | 0.64 | 1.12 | 1.95 | 34.2 |

A Kevlar ® 1F539, Type 979, Bale 102401587
B Twaron ® 1095, Charge 315200, 24 Jan. 2003
C Twaron ® 1099, Ser. no. 323518592, Art. no. 108692

### SR Determination

2 g (dry weight) of never dried pulp fibers were dispersed in 1 L water during 250 beats in a Lorentz and Wettre desintegrator. A well-opened sample is obtained. The Schopper Riegler (° SR) value is measured.

### SSA Determination

Specific surface area (m²/g) (SSA) was determined using adsorption of nitrogen by the BET specific surface area method, using a Tristar 3000 manufactured by Micromeretics. The dry pulp fibers samples were dried at 200° C. for 30 minutes, under flushing with nitrogen.

### EXAMPLE 1

### Preparation of (co)poly-1,4-phenylene-(2-hydroxy)-1,4-phenylene-terephthalamide.

TABLE 1
Polymerization conditions

| | |
|---|---|
| Monomer conc. wt % | 11 |
| CaCl₂, wt % (on NMP) | 8.23 |
| molar ratio amine:acid | 1.000 |
| molar ratio CaCl₂:amide | 1.067 |
| ηᵣₑₗ | 2.90 |

9.2779 g of para-phenylenediamine (PPD), 16.9064 g of 2,5-diaminophenol dihydrochloride (DAP), and 14.00 mL of pyridine (2 eq.) were dissolved in 300 mL of dry NMP/CaCl₂. The reactor was purged three times with nitrogen. The mixture was stirred for 30 min at 150 rpm. An ultrasonic bath was used for about 20 min to make sure the DAP was dissolved.

The mixture was cooled to 5° C. and after removing the coolant the stirrer speed was set at 320 rpm and 34.8351 g of terephthaloyldichloride (TDC) were added. The Erlenmeyer and funnel were rinsed with 150 mL dry NMP/CaCl₂. The mixture was stirred for 25 minutes and an ice bath was placed under the flask. The reaction was stirred for an additional 15 minutes. The green/yellow colored liquid product together with demi-water were added into a Condux™ LV1515/N3 coagulator and the mixture was collected on a RVS filter. The product was washed 4 times with 5 L demi-water and dried overnight in a vacuo oven at 70° C. The product was a green/yellow free flowing powder. The relative viscosity was 2.90.

### EXAMPLE 2

### Preparation of poly-1,4-phenylene-2-hydroxy-1,4-phenylene-terephthalamide Fibrids

Various polymerizations were done with DAP. The reaction was carried out under N₂ flow and with the use of the polymerization reactor of Example 1. Precisely weighed amounts of 2,5-di-aminophenol dihydrochloride with or without neutralizing compound were brought in 300 mL of dry NMP/CaCl₂. The reactor was purged three times with nitrogen. The mixture was stirred for 30 min at 150 rpm. An ultrasonic bath was used for about 20 min to make sure the DAP was dissolved as much as possible.

The mixture was cooled to 5° C. and after removing the coolant the stirrer speed was set at 320 rpm and a precisely weighed amount of TDC was added. The Erlenmeyer and funnel were rinsed with 150 mL of dry NMP/CaCl₂. The mixture was allowed to react for at least 60 min. The green colored liquid product together with demi-water were added into the Condux LV1515/N3 coagulator and the mixture was collected on a RVS filter. The product was washed 4 times with 5 L demi-water and dried overnight in a vacuo oven at 70° C. The results are summarized in Table 2.

TABLE 2
Polymerization conditions

| | |
|---|---|
| Monomer conc. wt % | 11 |
| CaCl₂ wt % (on NMP) | 8.23 |
| molar ratio amine:acid | 1.0 |
| molar ratio CaCl₂:amide | 1.2 |
| ηᵣₑₗ | 2.11 |

10 Grams of this sample were dissolved in 200 grams of 99.8% sulfuric acid and subsequently coagulated with a blender in a 1% H₂SO₄ solution and 1% HCl solution under vigorous stirring conditions. After coagulation the content was emptied on a vacuum filter and the fibrid cake was washed. Fiber length measurement was done using the Pulp Expert® FS (ex Metso) (Table 3).

TABLE 3

| | | | | | SR | |
|---|---|---|---|---|---|---|
| | AL_{0.25} | LL_{0.25} | WL_{0.25} | Fines | value | Dry solids |
| | (mm) | (mm) | (mm) | (%) | (°SR) | content (%) |
| Coagulated | 0.46 | 0.60 | 0.86 | 45.80 | 28.00 | 10.98 |
| in 1% H₂SO₄ | | | | | | |
| Coagulated | 0.47 | 0.60 | 0.81 | 47.10 | 40.00 | 9.05 |
| in 1% HCl | | | | | | |

### EXAMPLE 3

The preparation of poly-4,4′-(3,3′dihydroxy)-biphenylene-terephthalamide. The general polymerization procedure was as follows:

Four liters of solvent (NMP/CaCl₂, moisture<160 ppm) and pre-dried 4,4′-dihydroxybenzidine (DHB) (140° C., vacuum, 24 h) were put in a 10 L Drais reactor and stirred for 30 minutes to let the DHB dissolve. After cooling to 5° C. TDC was added while continuously stirring. After 60 minutes the reactor was emptied. The reaction product was coagulated with a Condux blender with demi-water and washed. The relative viscosity was determined.

When brought in contact with water the color of the reaction product changed to bright yellow. The product was dried for 24 hours under vacuum at 80° C. After coagulation, washing and drying, it became yellow tobacco-like.

Table 4 shows the polymerization conditions and the resulting relative viscosity for each batch.

TABLE 4
Polymerization features

| | |
|---|---|
| Monomer conc. (wt %) | 16.2 |
| CaCl₂ (wt % on solvent) | 11.02 |
| molar ratio amine:acid | 0.995 |
| molar ratio CaCl₂:amide | 1.08 |
| ηᵣₑₗ | 5.91 |

The tobacco-like material was characterized by its fiber length using the Pulp Expert® FS (ex Metso) (Table 5).

TABLE 5

| | | | | SR | | |
|---|---|---|---|---|---|---|
| AL_{0.25} | LL_{0.25} | WL_{0.25} | Fines | value | Dry solids | SSA |
| (mm) | (mm) | (mm) | (%) | (°SR) | content (%) | (m²/g) |
| 0.63 | 0.99 | 1.51 | 30.0 | 7.0 | 10.98 | 0.58 |

### EXAMPLE 4

Anisotropic Alkaline dope preparation.

6.8 g of poly(p-dihydroxy-biphenylene terephthalamide) as prepared in Example 3 were added to a dried round bottom flask equipped with a stainless steel mechanical stirrer. After the flask was cooled to room temperature (about 25° C.) 34 g of 1.5N tetramethylammoniumhydroxide (TMAH) solution in water were added. This temperature was maintained for several hours. By checking the solution at regular intervals under a light microscope the progress of dissolving was monitored. After 95% of the polymer particles were dissolved the solution was heated to 50° C. and mixed for 40 minutes to obtain a homogeneous high viscous solution. The resulting dope exhibits stir-opalescence and depolarizes plane-polarized light. The clearing temperature of this dope could not be detected because it was higher than the boiling point of the solvent.

This spin dope was transferred into a cylinder and heated above its melting temperature under vacuuming for degassing. The liquid crystalline solution was then extruded by means of a mechanically drive syringe through a thick metal spinneret having a hole of 150 microns diameter into an aqueous coagulating bath at 25° C. After passing through the bath for about 30 cm the yarn was snubbed out of the water at about a 45° angle to an electrically driven wind-up device. The yarn was collected on a stainless steel bobbin at 120 m/min. It was then washed in cool running water for several hours and dried under vacuum at room temperature on the bobbin.

The spun and dried poly(p-dihydroxy-biphenylene terephthalamide) yarn was wound on a rigid metal frame and heated to 450° C. for 5 minutes in an inert atmosphere (N₂). The chemical structure of the light brown yarn was identified as a benzoxazole by IR spectroscopy. TGA analysis of the spun precursor fiber (10°/min, N₂) showed a maximum speed of weight loss around 410° C., followed by a stable region between 450 and 610° C. The measured weight loss by cyclization is 10.8% and this value is in close agreement with theoretical value of 10.5%. This indicates that the conversion has progressed quantitatively. The onset degradation temperature was 630° C. (5% weight loss). The measured results are shown in Tables 6 and 7. The Draw ratio is defined as the ratio between Winding velocity and extrusion velocity.

TABLE 6
(polybenzoxazole precursor yarn)
As-spun

| Linear | Draw | Breaking | Modulus |
|---|---|---|---|
| density (dtex) | ratio | tenacity (mN/tex) | (GPa) |
| 1.63 | 30.2 | 1347 | 72.3 |

TABLE 7
(polybenzoxazole yarn)
Heat treated

| Linear | Breaking | Modulus |
|---|---|---|
| density (dtex) | tenacity (mN/tex) | (GPa) |
| 1.41 | 1156 | 110.8 |

### EXAMPLE 5

2.25 liters of NMP/CaCl₂ and 1.75 liters of NMP together with pre-dried DHB (140° C., vacuum, 24 h) were put in a 10 L Drais reactor and stirred for 30 minutes to let the DHB dissolve. After cooling to 5° C. TDC was added under continuous stirring (250 rpm). After 50 minutes a sample was taken and 1.8 L of NMP were added. The mixture was stirred for 30 min, another sample was taken and again 1.8 L of NMP were added. The mixture was stirred for 30 min and the reactor was emptied. By applying this procedure, the first sample had a polymer concentration of 7.4%, the second sample (after dilution with NMP) had a concentration of 5% and the final product had a polymer concentration of 4%. The relative viscosity of the reaction product was 3.43.

The polymerization procedure for the second batch was similar, except that after 60 minutes a sample was taken and 4.0 L of NMP were added. The mixture was stirred for 30 min and then emptied. By applying this procedure, the first sample had a polymer concentration of 7.4% and the final product had a polymer concentration of 4%. The relative viscosity of the reaction product was 3.06.

The polymerization batches were mixed prior to spinning.

### Fibrids Spinning

The solution was spun through a jet spinning nozzle (spinning hole 500 mm) at 20 L/h. Water was added through a ring-shaped channel flowing perpendicular to the polymer flow. During spinning the polymer flow was kept constant while the coagulant pressure was changed for the different samples in order to vary the SR (° SR) of the product.

### Pulp Spinning

The specific solutions were spun into pulp using the conditions of Table 8 through a 1 hole jet spinning nozzle (spinning holes 350 mm). The solution was spun into a zone of lower pressure. An air jet was applied perpendicularly to the polymer stream through ring-shaped channels to the same zone were expansion of air occurred. Thereafter, the pulp was coagulated with water in the same zone by means of applying a coagulant jet through ring-shaped channels under an angle in the direction of the polymer stream.

To spin the pulp with different SR values (° SR) the air pressure was kept constant while the polymer flow was varied. After spinning all samples were washed with water.

TABLE 8

| | | | | | PulpExpert FS | | Schopper | | |
|---|---|---|---|---|---|---|---|---|---|
| | polymer | coagulant | coagulant | Air | (PE) | | Riegler SR | Tristar | Dry |
| product | flow | pressure | flow | flow | LL_{0.25} | Fines | value | SSA | Solids |
| type | (L/h) | (bar) | (L/h) | (Nm³/hr) | (mm) | (%) | (°SR) | (m²/g) | (%) |
| pulp | 6 | | 50 | 12 | 0.58 | 43.3 | 63 | 0.6 | 5.3 |
| fibrid | 20 | 50 | | | 0.72 | 25.0 | 67 | 0.5 | 7.3 |

Effect of the Present Invention

The fiber of the present invention comprises aromatic polybenzazole and has superior mechanical properties such as elastic modulus and strength. The fiber of the present invention contains no or only minor quantities of phosphorous compound while maintaining the superior hydrolysis resistance of aromatic polybenzazole.

Moreover, according to the present method of manufacturing it is possible to make a fiber comprising aromatic polybenzazole without using a phosphorous compound such as polyphosphoric acid. According to the method of manufacturing it is an advantage to use an acidic solvent that can be easily removed by washing with water and is less likely to leave residues within the fibers. A further advantage is that the remaining solvent can be removed in a short time by washing with water. The polymers and the fiber, pulp, fibril, or fibrid made thereof have a phosphorous content below 10 ppm.

The fibers of the present invention can be utilized, for example, as rope, belt, insulating fabric, reinforcement of resin, and protective clothing material.

1. A fiber, pulp, fibril, or fibrid comprising polybenzazole having a repeating unit of formula (I) and/or (II) 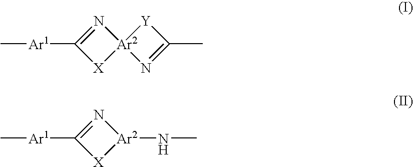
wherein Ar¹ and Ar² are independently an aromatic group having 4 to 12 carbon atoms, Ar¹ has the para configuration, and
X and Y are the same or different and selected from O, S, and NH; and
wherein fiber contains between 30.1 ppm and 1500 ppm of non-extractable phosphorus compound, and pulp, fibril, or fibrid contains less than 1500 ppm of non-extractable phosphorus compound if X and Y are the same.

2. The fiber, pulp, fibril, or fibrid of claim 1 comprising 40-100 mole % of the repeating unit (I) and/or (II) and to a total of 100 mole % of a repeating unit of the formula (III)

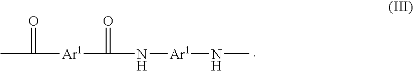

3. The fiber, pulp, fibril, or fibrid of claim 2 comprising 60-100 mole % of the repeating unit (I) and/or (II) and to a total of 100 mole % of the repeating unit of the formula (III).

4. A fiber, pulp, fibril, or fibrid comprising a polybenzazole precursor comprising a repeating unit, wherein an aromatic group is substituted with group XH and optionally with group YH, having formula (IV): 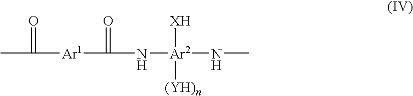
wherein Ar¹ and Ar² are independently an aromatic group having 4 to 12 carbon atoms, Ar¹ and Ar² have the para configuration, X and Y are the same or different and selected from O, S, and NH, and n is 0 or 1.

5. The fiber, pulp, fibril, or fibrid of claim 4 comprising 40-100 mole % of the repeating unit (IV) and to a total of 100 mole % of a repeating unit of the formula (III)

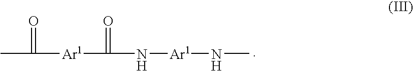

6. The fiber, pulp, fibril, or fibrid of claim 5 comprising 60-100 mole % of the repeating unit (IV) and to a total of 100 mole % of the repeating unit of the formula (III).

7. The fiber, pulp, fibril, or fibrid of claim 1 wherein Ar¹ and Ar² are independently selected from:

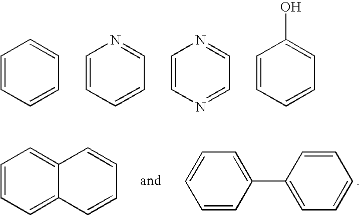

8. The fiber, pulp, fibril, or fibrid of claim 7 wherein Ar¹ and Ar² are a benzene moiety, or Ar¹ is a phenylbenzene moiety and Ar² is a benzene moiety, and X is O.

9. The fiber, pulp, fibril, or fibrid of claim 4 wherein the polybenzazole comprises at least the aromatic groups with the formulae:

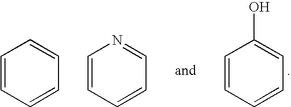

10. A method of obtaining the fiber, pulp, fibril, or fibrid of claim 1 comprising the steps of:
extruding a solution comprising 25 to 100 mole % of a polybenzazole precursor and to a total of 100 mole % of polybenzazole polymer in a phosphoric acid-free dope through a die or spinneret to obtain a fiber, pulp, fibril, or fibrid;
drawing the fiber across an air gap;
coagulating the fiber, fibril, pulp, fibrid or film in a coagulation bath;
optionally washing the fiber, fibril, pulp, fibrid or film; and
optionally drying the fiber, fibril, pulp, fibrid or film;
heat treating the fiber, fibril, pulp, fibrid or film to convert the polybenzazole precursor consisting of repeating units selected from 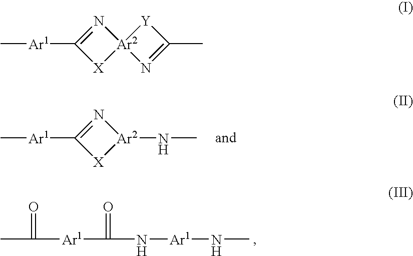
to the polybenzazole polymer consisting of repeating units selected from 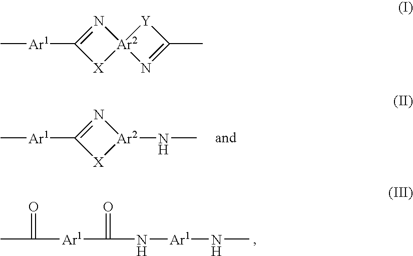
wherein Ar¹ and Ar² are independently an aromatic group having 4 to 12 carbon atoms, Ar¹ has the para configuration and 40 -100% of the repeating units are repeating unit I and/or repeating unit II and wherein the polybenzazole contains less than 1500 ppm of non-extractable phosphorus compound if 100% of the repeating units are repeating unit I and/or repeating unit II and X and Y are the same;
optionally followed by washing and drying steps.

11. The method according to claim 10 wherein heat treating the fiber or pulp is performed under an inert atmosphere at 250 to 600° C. for 0.5 sec to 24 h.

12. The method according to claim 10 wherein the dope is water, sulfuric acid, or NMP/CaCl₂.

13. The method according to claim 12 wherein the dope is water having pH>8.

14. The method according to claim 13 wherein the dope is water containing sodium hydroxide and/or tetramethylammonium hydroxide.
